(19) United States
(12) Patent Application Publication
(10) Pub. No.: US 2026/0318872 A1
(43) Pub. Date: Oct. 15, 2026

(54) SENSORIZED DEVICE FOR THE ANALYSIS OF A FLUID IN REAL TIME USING ACOUSTIC WAVES

(71) Applicant: INTA SRL, Pisa (IT)

(72) Inventors: Matteo AGOSTINI, Pisa (IT); Marco CECCHINI, Calci (IT); Francesco LUNARDELLI, La Spezia (IT)

(73) Assignee: INTA SRL, Pisa (IT)

(21) Appl. No.: 19/485,254

(22) PCT Filed: May 20, 2024
(86) PCT No.: PCT/IB2024/054888

§ 371 Date: Nov. 17, 2025

(30) Foreign Application Priority Data
May 18, 2023 (IT) 102023000010053

(51) Int. Cl. G01N 29/02; G01N 29/24

(52) U.S. Cl. CPC G01N 29/022; G01N 29/2437; G01N 2291/022; G01N 2291/101

(57) ABSTRACT

A sensorized device for detecting analytes within a fluid comprising a piezoelectric substrate having an outer surface, at least one R-SAW emitting interdigital transducer arranged on the outer surface and arranged to emit a surface acoustic wave of the Rayleigh type, also-called R-SAW, in response to an electrical input signal, said R-SAW being emitted along a first emission direction x, and at least one SH-SAW emitting interdigital transducer arranged on the outer surface and arranged to emit a surface acoustic wave of the shear-horizontal type, also-called SH-SAW, in response to an electrical input signal, said SH-SAW being emitted along a second emission direction y.

### FIELD OF THE INVENTION

The present invention concerns the analysis of fluids and the detection of specific analytes of interest.

In particular, the invention concerns the detection of such analytes by means of surface acoustic waves generated by micro or nanostructured sensors.

### DESCRIPTION OF THE PRIOR ART

In recent years, in the field of scientific and industrial research, there has been a notable increase in the development of biosensors capable of performing accurate, rapid analyzes without the aid of complex machinery typical of a specialized laboratory. The aim is to integrate and, in some cases, replace classic diagnostic techniques, extending detection directly “on-field”.

In this scenario, “lab-on-chip” (LoC) sensors are considered a real game changer. LoCs are micro or nanostructured devices capable integrating multiple functions into a single chip, typical of a specialized laboratory. These operations include: analyte detection, reagent mixing, particle heating and separation.

In the biomedical field the key characteristics of LoCs consist of highly specific recognition of biomarkers and integration with micro-fluidics. These devices are in fact able to manipulate small volumes of biological samples (of the order of magnitude of microliters) and to provide a specific and sensitive response following the recognition of the analyte of interest.

LoCs are portable sensors, economical and easy to use even by unskilled personnel. They therefore present great potential for impact on the future of public health. Among the most significant examples of the fields of use of Loc devices we have: health surveillance, infectious disease screening, early diagnosis of chronic diseases and environmental and agri-food monitoring.

In the field of Loc sensors, devices based on surface acoustic waves (SAW) find an ideal use. SAWs, given their high surface confinement, are particularly sensitive to external perturbations, and in particular to the detection of attached mass which induces changes in the wave propagation characteristics (“mass-loading”effect) .

As known, SAWs are generated using interdigital transducers. In particular, an interdigital transducer (IDT) is a device that consists of two interconnected comb-shaped arrays of metal electrodes (“fingers”). These metal electrodes are deposited on the surface of a piezoelectric substrate, such as quartz or lithium niobate, to form a periodic structure. Thanks to this structure, an interdigital transducer is able to convert electrical signals into SAW by generating periodically distributed mechanical forces via the piezoelectric effect. The same principle is applied to converting SAW back into electrical signals. These SAW generation and reception processes can be used in different types of SAW signal processing devices, such as bandpass filters, delay lines, resonators, sensors, etc.

SAWs can be generated and detected in a controlled manner by exploiting the electromechanical coupling between electrodes with well-defined geometry and piezoelectric substrates. By combining these characteristics of SAW with an appropriate functionalization of the surface, it is possible to create completely electrically read-out sensors, capable of detecting specific biomarkers such as, for example, proteins that allow the diagnosis of pathologies.

Among the various types of SAW, the Rayleigh SAW (R-SAW) and the shear-horizontal SAW (SH-SAW) are distinguished.

In particular, R-SAWs can also be used for the mixing and manipulation of liquids in microfluidic channels. Devices have been created capable of exploiting the potential of R-SAW both in the detection (dry) and in the manipulation of liquids. An example of such devices is shown in M. Agostini, G. Greco, M. Snipers “A Rayleigh surface acoustic wave (R-SAW) resonator biosensor based on positive and negative reflectors with sub-nanomolar detection limit”. Sensors and Actuators B 254 (2018).

On the other hand, SH-SAWs are capable of carrying out real-time analyzes in liquid samples, thanks to their polarization tangential to the propagation surface. With this in mind, biosensors have been developed that exploit SH-SAW for the detection of analytes in biological fluids. An example of such biosensors is shown in U.S. Pat. No. 10,031,135B2.

In light of what has been said, there is a need for SAW sensors capable of exploiting both R-SAW and SH-SAW in an integrated manner using a common substrate.

However, currently, state-of-the-art saw sensors

are generally directed at R-SAW generation or, alternatively, SH-SAW generation. An example can be found in U.S. Pat. No. 10,031,140, in which a device is described having a substrate suitable for the generation of R-SAW (128° YX LiNbO3), which however is not suitable for the generation of SH-SAW. The document also explicitly says that the integration of R-SAW and SH-SAW requires the presence of different substrates.

In the literature there are some examples of sensors that make use of piezoelectric substrates capable of generating both R-SAW and SH-SAW, such as “Liquid sensor using SAW and SH-SAW on quartz” (Takashi Kogai, Hiromi Yatsuda IEEE Ultrasonic Symposium, 2006) and “Orthogonal surface acoustic wave device based on langasite for simultaneousus biosensing and biofouling removal” (Singh, Reetu & Sankaranarayanan, Subramanian & Bhethanabotla Appl. Phys. Lett. 94, 263503; 2009). In particular, in the first document an ST-cut piezoelectric quartz substrate is used, while in the second a langasite piezoelectric substrate is used. However, in both cases a low value of the electromechanical coupling coefficient k² is obtained, resulting in low efficiency in the generation of acoustic waves and, in particular, in the mixing of liquids.

Another example is shown in “Rayleigh SAW assisted SH-SAW immunosensor on X-cut 148-Y LiTa O3” (Takashi Kogai, Hiromi Yatsuda, and Ja Kondoh ; IEEE Trloopctions on Ultrasonics, ironelectrics, and Frequency control, vol. 64, no. 9), in which a piezoelectric substrate of lithium tantalate is used. However, in this document the transducers capable of generating the two surface waves must be arranged at a precise angle of 9 ° with respect to the direction of propagation of the SAW, leading to considerable complications in the manufacture of the device as well as reduced efficiency.

### SUMMARY OF THE INVENTION

It is therefore a feature of the present invention to provide a sensorized device for detecting analytes within a fluid which allows to generate both Rayleigh type surface acoustic waves (R-SAW), for the mixing and manipulation of liquids, and shear-horizontal surface acoustic waves (SH-SAW), for the real-time detection of analytes in a liquid environment.

It is also a feature of the present invention to provide such a sensorized device which has a high value of the electromechanical coupling coefficient k².

It is still a feature of the present invention to provide such a sensorized device which reduces the complexity and manufacturing costs compared to the prior art.

These and other objects are achieved by a sensorized device for detecting analytes within a fluid, said sensorized device comprising:
a piezoelectric substrate having an outer surface;
at least one R-SAW emitting interdigital transducer arranged on said outer surface, said R-SAW emitting interdigital transducer arranged to emit a surface acoustic wave of the Rayleigh type, also-called R-SAW, in response to an electrical input signal, said R-SAW being emitted along a first emission direction x;
at least one SH-SAW emitting interdigital transducer arranged on said outer surface, said SH-SAW emitting interdigital transducer arranged to emit a surface acoustic wave of the shear-horizontal type, also-called SH-SAW, in response to an electrical input signal, said SH-SAW being emitted along a second emission direction y;
   whose main feature is that said piezoelectric substrate is made in a material selected from 64 ° Y-cut lithium niobate and 163 ° Y-cut lithium niobate, in such a way that said piezoelectric substrate supports as its main mode surface acoustic waves of the shear-horizontal type, the main mode being defined as the surface acoustic wave exhibiting greater electromechanical coupling on said piezoelectric substrate, and that said first emission direction x and said second emission direction y have a relative angle α in such a way that 80°<α<100°.

In this way, the present invention allows the generation of both Rayleigh type surface acoustic waves (R-SAW), for the mixing and manipulation of liquids, and shear-horizontal type surface acoustic waves (SH-SAW), for the real-time detection of analytes in a liquid environment.

Furthermore, compared to prior art devices that use quartz or langasite substrates, the present invention allows a notable increase in the electromechanical coupling coefficient k². In particular, using a lithium niobate substrate gives a k² range that goes from 5.5% to 17.2% (depending on the cuts) compared to a k² equal to 0.14% for quartz and 0.36% for langasite.

Compared instead to devices of the prior art which use lithium tantalate substrates with transducers arranged at a precise angle of 9°, there is an advantage in terms of manufacturing of the sensor itself, as the angle a used in the present invention allows significantly greater error tolerance.

Advantageously, there is 85°<α<95°.

In particular, each R-SAW emitting interdigital transducer and each SH-SAW emitting interdigital transducer comprise respective plurality of fingers having width p and height h, wherein the ratio p/h is set between 0.2% and 0.5%.

In particular, a R-SAW reflector arranged on said outer surface is also provided arranged to reflect said R-SAW towards said R-SAW emitting interdigital transducer.

In particular, a SH-SAW reflector arranged on said outer surface is also provided arranged to reflect said SH-SAW towards said SH-SAW emitting interdigital transducer.

In particular, the surface acoustic waves emitted by each R-SAW emitting interdigital transducer and by each SH-SAW emitting interdigital transducer have an optimal range of frequencies set between 800 MHz and 1.6 GHz.

Advantageously, at least one microfluidic channel is also provided arranged to convey said fluid along a predetermined path on said outer surface, in order to allow the containment of said fluid within a small area in which said analysis takes place.

### BRIEF DESCRIPTION OF THE DRAWINGS

The invention will be now shown with the following description of some exemplary embodiments, exemplifying but not limitative, with reference to the attached drawings in which:

FIG. 1 shows an embodiment of the sensorized device, according to the present invention, wherein a R-SAW emitting interdigital transducer and a SH-SAW emitting interdigital transducer are provided arranged at 90° to each other;

FIG. 2 shows an embodiment of the sensorized device, according to the present invention, wherein two R-SAW emitting interdigital transducers, a SH-SAW emitting interdigital transducer and two SH-SAW reflectors are provided;

FIG. 3 shows an embodiment of the sensorized device, according to the present invention, wherein a R-SAW emitting interdigital transducer, a SH-SAW emitting interdigital transducer, two R-SAW reflectors and two SH-SAW reflectors are provided;

FIG. 4 shows an embodiment of the sensorized device, according to the present invention, wherein four R-SAW emitting interdigital transducers, a SH-SAW emitting interdigital transducer, two R-SAW reflectors and two SH-SAW reflectors are provided.

### DESCRIPTION OF SOME PREFERRED EXEMPLARY EMBODIMENTS

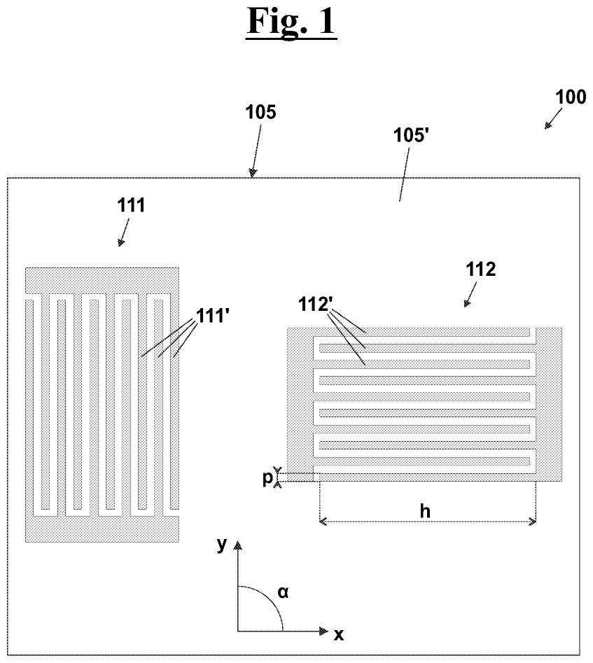

With reference to FIG. 1, the sensorized device 100 for detecting analytes within a fluid, according to the present invention, comprises a piezoelectric substrate 105 having an outer surface 105′, a R-SAW emitting interdigital transducer 111 and a SH-SAW emitting interdigital transducer 112, both arranged on the outer surface 105′.

In particular, the R-SAW emitting interdigital transducer 111 is arranged to emit a surface acoustic wave of the Rayleigh type, also-called R-SAW, along a first emission direction x, whereas the SH-SAW emitting interdigital transducer 112 is arranged to emit a surface acoustic wave of the shear-horizontal type, also-called SH-SAW, along a second emission direction y, which is arranged at an angle α=90° with respect to the first emission direction x.

Furthermore, according to the invention, the piezoelectric substrate 105 is made with lithium niobate crystals cut according to an orientation such that the piezoelectric substrate 105 supports as its main mode surface acoustic waves of the shear-horizontal type, the main mode being defined as the surface acoustic wave exhibiting greater electromechanical coupling on the piezoelectric substrate 105.

In particular, the piezoelectric substrate 105 can be made of one of the following materials:
64° Y-cut lithium niobate;
163° Y-cut lithium niobate.

Thanks to the particular material of the substrate 105 and the orthogonal arrangement of the x and y emission axes, the sensorized device 100, according to the present invention, allows obtaining a high value of the electromechanical coupling coefficient k², together with a reduced manufacturing complexity compared to the prior art.

The embodiment shown in FIG. 1 can be used both for “detection in liquid”, thanks to the generation of SH-SAW, and for “detection in dry”, thanks to the generation of R-SAW. In particular, “detection in liquid” means that the acquisition of the resonance occurs when the sensor is wet. Therefore, this measurement is suitable for “real time” monitoring of the adhesion of the analyte found in the liquid sample to the sensor. By “dry detection” we mean that the resonance acquisition takes place on a dry sensor. Then, the sensor is wetted with the sample containing the analyte, then dried and the resonance acquisition subsequently takes place.

Furthermore, in the embodiment of FIG. 1 the generation of R-SAW allows mixing of liquid samples, with positive effects regarding the specific adhesion of analytes.

As is known, again with reference to FIG. 1, the interdigital emitting transducers 111 and 112 comprise respective pluralities of “fingers” 111′ and 112′, having width p and height h. Advantageously, the p/h ratio is between 0.2% and 0.5%. Therefore, if h has a typical value of 100 nm, the p-value is between 0.4 and 1.0 μm. These ranges of values correspond to surface acoustic waves having an optimal frequency range between 800 MHz and 1.6 GHz.

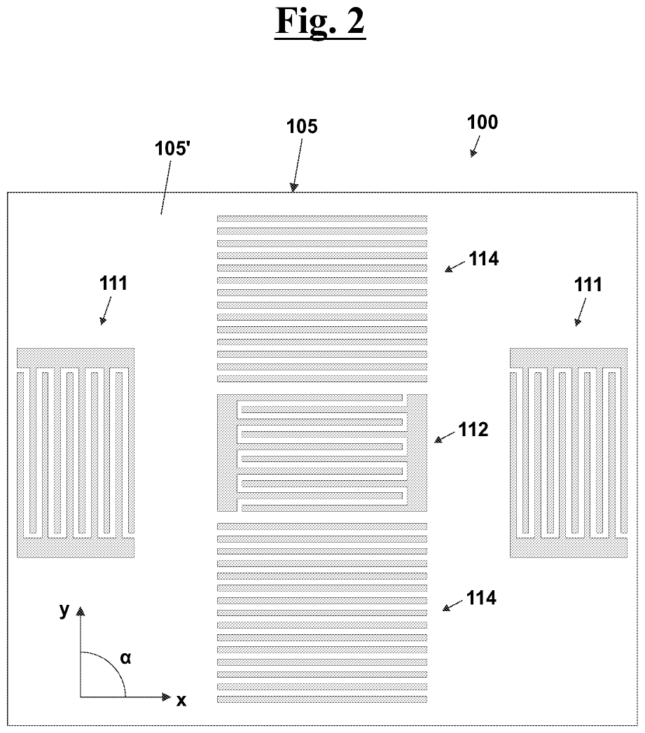

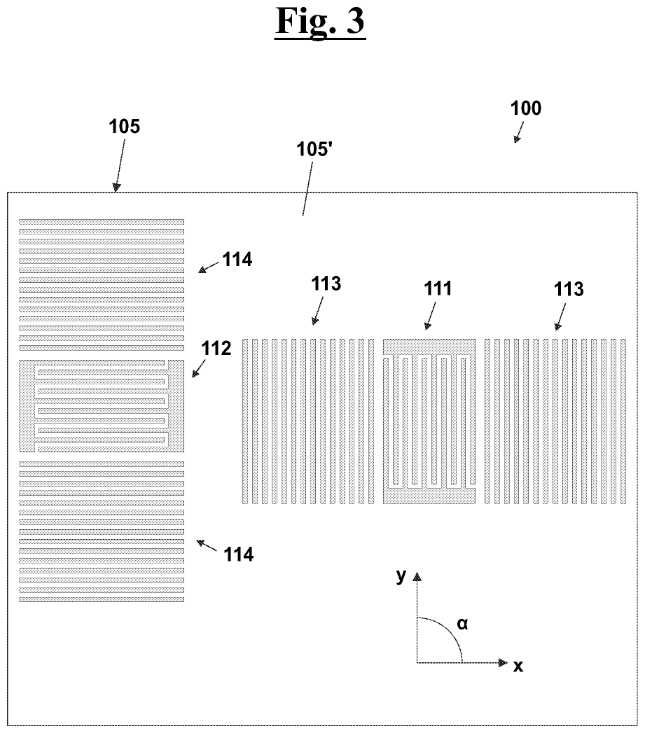

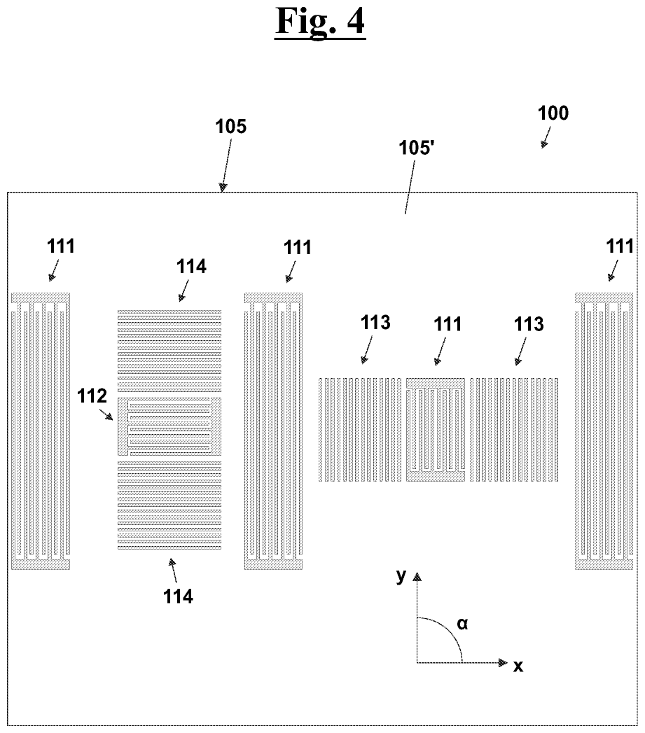

With reference to FIGS. 2, 3 and 4, the sensorized device 100 can comprise several R-SAW emitting interdigital transducers and several SH-SAW emitting interdigital transducers, according to the reasons of use.

Furthermore, at least one R-SAW reflector 113 and at least one SH-SAW reflector 114 can be provided, constituting a resonator configuration. This configuration guarantees greater spatial confinement of the surface wave which transforms into a standing wave, resulting in greater energy confinement in the sensitive area. Furthermore, this configuration causes an increase in the Q-factor of the resonance peak of the S11 reflection analysis. In this way, there is an increase in the efficiency of identifying analytes in the fluid.

The foregoing description exemplary embodiments of the invention will so fully reveal the invention according to the conceptual point of view, so that others, by applying current knowledge, will be able to modify and/or adapt for various applications such embodiment without further research and without parting from the invention, and, accordingly, it is therefore to be understood that such adaptations and modifications will have to be considered as equivalent to the specific embodiments. The means and the materials to realise the different functions described herein could have a different nature without, for this reason, departing from the field of the invention. It is to be understood that the phraseology or terminology that is employed herein is for the purpose of description and not

1. A sensorized device for detecting analytes within a fluid, said sensorized device comprising:
a piezoelectric substrate having an outer surface;
at least one R-SAW emitting interdigital transducer arranged on said outer surface, said R-SAW emitting interdigital transducer arranged to emit a surface acoustic wave of the Rayleigh type, also-called R-SAW, in response to an electrical input signal, said R-SAW being emitted along a first emission direction x;
at least one SH-SAW emitting interdigital transducer arranged on said outer surface, said SH-SAW emitting interdigital transducer arranged to emit a surface acoustic wave of the shear-horizontal type, also-called SH-SAW, in response to an electrical input signal, said SH-SAW being emitted along a second Emission direction y;
wherein said piezoelectric substrate is made in a material selected from 64° Y-cut lithium niobate and 163° Y-cut lithium niobate, in such a way that said piezoelectric substrate supports as its main mode surface acoustic waves of the shear-horizontal type, the main mode being defined as the surface acoustic wave exhibiting greater electromechanical coupling on said piezoelectric substrate
and wherein said first emission direction x and said second emission direction y have a relative angle a in such a way that 80°<α<100°.

2. A sensorized device, according to claim 1, wherein 85°<α<95°.

3. A sensorized device, according to claim 1, wherein each R-SAW emitting interdigital transducer and each SH-SAW emitting interdigital transducer comprise respective plurality of fingers having width p and height h, and where the ratio p/h is set between 0.2% and 0.5%.

4. A sensorized device, according to claim 1, wherein an R-SAW reflector is also provided arranged on said outer surface, said R-SAW reflector arranged to reflect said R-SAW towards said R-SAW emitting interdigital transducer.

5. A sensorized device, according to claim 1, wherein a SH-SAW reflector is also provided arranged on said outer surface, said SH-SAW reflector arranged to reflect said SH-SAW towards said SH-SAW emitting interdigital transducer.

6. A sensorized device, according to claim 1, wherein the surface acoustic waves emitted by each R-SAW emitting interdigital transducer and by each SH-SAW emitting interdigital transducer have an optimal range of frequencies set between 800 MHz and 1.6 GHz.

7. A sensorized device according to claim 1, wherein at least one microfluidic channel is also provided arranged to convey said fluid along a predetermined path on said outer surface, in order to allow the containment of said fluid within a small area in which said analysis takes place.
